(19) United States
(12) Patent Application Publication
(10) Pub. No.: US 2005/0109957 A1
(43) Pub. Date: May 26, 2005

(54) Activating/processing apparatus for liquid fuel

(76) Inventor: Chin-Ching Chang, Taichung (TW)

Correspondence Address: BRUCE H. TROXELL, SUITE 1404, 5205 LEESBURG PIKE, FALLS CHURCH, VA, 22041, US

(21) Appl. No.: 10/716,626

(22) Filed: Nov. 20, 2003

(51) Int. Cl. F23K 5/08; F02M 27/00

(52) U.S. Cl. 250/526; 123/538; 250/492.1

(57) ABSTRACT

An activating/processing apparatus for liquid fuel, including an enclosing/binding sleeve made of highly elastic and heat-resistant gum material. The enclosing/binding sleeve has a substantially annular cross-section having a split. The enclosing/binding sleeve defines a central interior holding space for a fuel pipeline to pass therethrough. The wall of the enclosing/binding sleeve is formed with several axial receiving passages, whereby a far-infrared generating unit can be placed in each receiving passage. The liquid fuel pipeline can be highly elastically and easily held and bound in the holding space of the enclosing/binding sleeve. The enclosing/binding sleeve can be easily stretched for conveniently mounting the enclosing/binding sleeve on the pipeline. The far-infrared generating units are evenly distributed and accommodated in the receiving passages of the enclosing/binding sleeve to evenly provide co-vibration effect for the fuel in the pipeline.

### BACKGROUND OF THE INVENTION

The present invention is related to an improved activating/processing apparatus for liquid fuel. The activating/processing apparatus includes an enclosing/binding sleeve made of highly elastic and heat-resistant gum material. Several far-infrared generating units are accommodated in the annular wall of the enclosing/binding sleeve. A liquid fuel pipeline can be easily elastically and detachably held and bound in the enclosing/binding sleeve. The far-infrared generating units are evenly distributed to evenly provide processing effect for the fuel in the pipeline.

It is known that the waste gases exhausted from mobiles and factories seriously pollute the global environments. Also, the consumption of energy resource is increased with the rapidly increased mobiles. Therefore, many kinds of products for solving the problems of pollution and consumption of the energy have been developed. For example, Taiwanese Patent Application No. 87217462, entitled “fluid processor” discloses a liquid fuel processor mainly composed of two integrally formed mating bodies. The two mating bodies are integrally connected via a thin connecting plate at one end. The other end has an opening so that the mating bodies form a U-shaped body. The mating bodies can be resiliently opened or closed with the connecting end serving as a fulcrum. The opposite faces of the mating bodies are recessed to form an arched section. In addition, the mating bodies are formed with receiving cavities for accommodating therein a biochemical ceramic/enamel material. The biochemical ceramic/enamel material is made of zirconium, aluminum, titanium, silicon, zinc, strontium, vanadium, barium and many kinds of microminerals. The biochemical ceramic/enamel material can radiate far-infrared energy through media. This is able to eliminate the unstability of various fuels. Also, this can decompose the fuel from coarse particles into micro-particles or atomize the fuel for full combustion. The above liquid fuel processor can be resiliently stretched via the opening of the end to resiliently clamp and hold the liquid fuel pipeline in the arched sections of the mating bodies. When the fuel flows through the liquid fuel processor, the biochemical ceramic/enamel material in the processor can instantaneously convert the large molecular groups of the fluid into small molecular groups by means of the complex effect of reduction of the contained angle of hydrogen bond and breakage of the hydrogen bond. (This pertains to prior art and will not be further described hereinafter.) Such liquid fuel processor is applicable to the fuel pipeline of a mobile to enhance the combustion efficiency of the fuel in the engine. Moreover, the liquid fuel processor is able to lower fuel consumption, reduce exhaust gas and enhance the horsepower of the engine and acceleration of the mobile. However, the above liquid fuel processor is integrally formed and the portion of the liquid fuel processor in which the biochemical ceramic/enamel material is filled is sealed and cannot be opened. Therefore, it is impossible to replace the biochemical ceramic/enamel material. Furthermore, the mating bodies are made of hard plastic material. When installed, it is necessary to forcedly enlarge the opening between the mating bodies so as to hold the fuel pipeline. This is inconvenient. Furthermore, in the case that the specification of the pipeline fails to match with the size of the liquid fuel processor, the pipeline is apt to be abnormally compressed and deformed. This may block the pipeline. On the other hand, the liquid fuel processor may be too loose to hold the pipeline. This will affect the processing effect.

### SUMMARY OF THE INVENTION

It is therefore a primary object of the present invention to provide an improved activating/processing apparatus for liquid fuel, including an enclosing/binding sleeve made of highly elastic and heat-resistant gum material (such as rubber complex material). The enclosing/binding sleeve has a substantially annular cross-section having a split. The enclosing/binding sleeve defines a central interior holding space for a fuel pipeline to pass therethrough. The wall of the enclosing/binding sleeve is formed with several axial receiving passages, whereby a far-infrared generating unit can be placed in each receiving passage. The enclosing/binding sleeve can be easily elastically stretched to directly enlarge the size of the split. Accordingly, the fuel pipeline can be easily held and bound in the holding space of the enclosing/binding sleeve. By means of the high elasticity and softness of the enclosing/binding sleeve, the pipeline can be fully snugly tightly clamped in the holding space. Therefore, the enclosing/binding sleeve is adaptable to various diameters of pipelines.

It is a further object of the present invention to provide the above activating/processing apparatus for liquid fuel, in which at least one of the inner and outer circumferential faces of the enclosing/binding sleeve is formed with several channels along the adjoining sides of each two adjacent receiving passages. Accordingly, the enclosing/binding sleeve can be more easily stretched to facilitate the installation of the activating/processing apparatus on the fuel pipeline.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a perspective view showing the application of the present invention; and

FIG. 4 is a sectional view showing that the present invention is stretched.

### DETAILED DESCRIPTION OF THE PREFERRED EMBODIMENTS

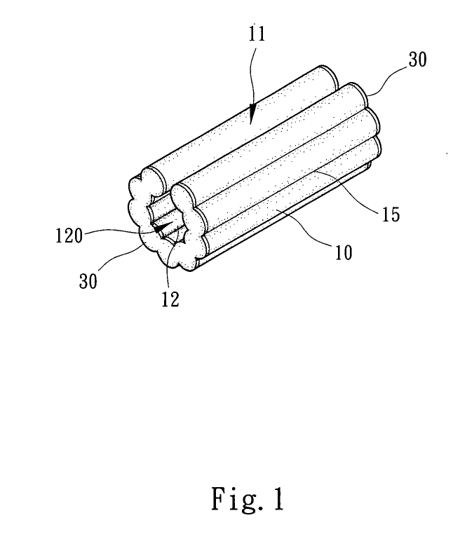

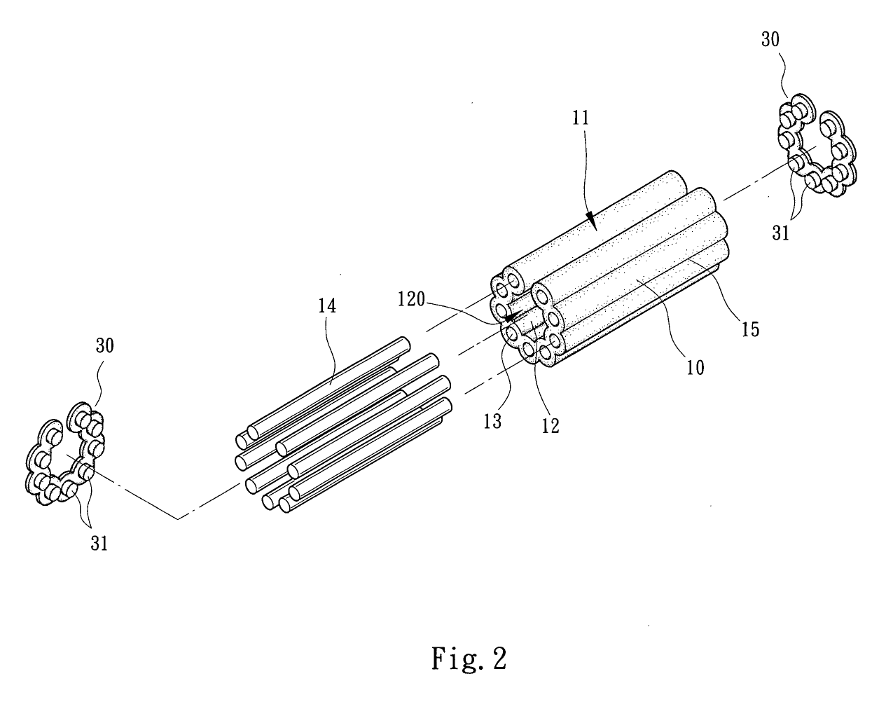

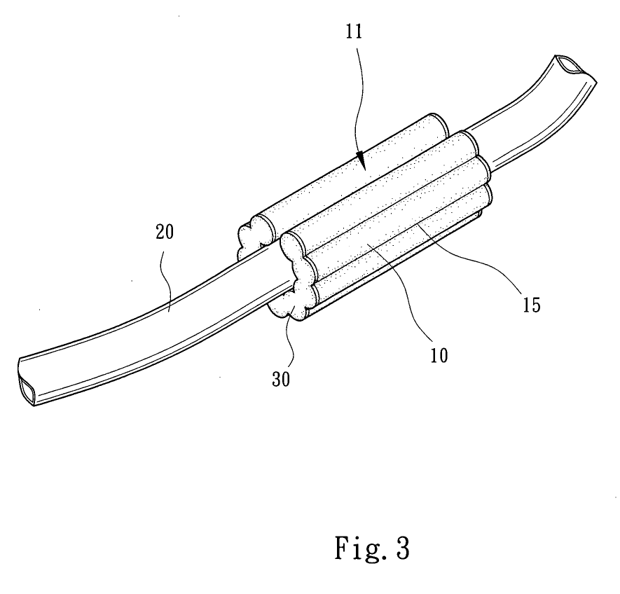

Please refer to FIGS. 1 to 4. The present invention includes an enclosing/binding sleeve 10 made of highly elastic and heat-resistant gum material with a certain length. The enclosing/binding sleeve 10 has a substantially annular cross-section having a split 11. The enclosing/binding sleeve 10 defines a central interior space 12 serving as a holding space 120 through which a fuel pipeline 20 can pass. In addition, the wall of the enclosing/binding sleeve 10 is formed with several axial receiving passages 13. A far-infrared generating unit 14 is placed in each receiving passage 13. The far-infrared generating unit 14 can be a cylindrical body which can be snugly inserted in the receiving passage 13.

A sealing cap 30 is fitted on at least one end of the enclosing/binding sleeve 10 for sealing the receiving passages 13 and protecting the far-infrared generating units 14 received in the receiving passages 13. The sealing cap 30 has a profile corresponding to the cross-section of the enclosing/binding sleeve 10. At least one face of the sealing cap 30 is formed with at least one cylindrical plug 31 corresponding to the position and configuration of the receiving passage 13. Accordingly, the sealing cap 30 can be resiliently tightly fitted with the sleeve 10 to seal the receiving passages 13. In the case that it is necessary to replace the far-infrared generating units 14, the sealing cap 30 can be unplugged to easily replace the far-infrared generating units 14.

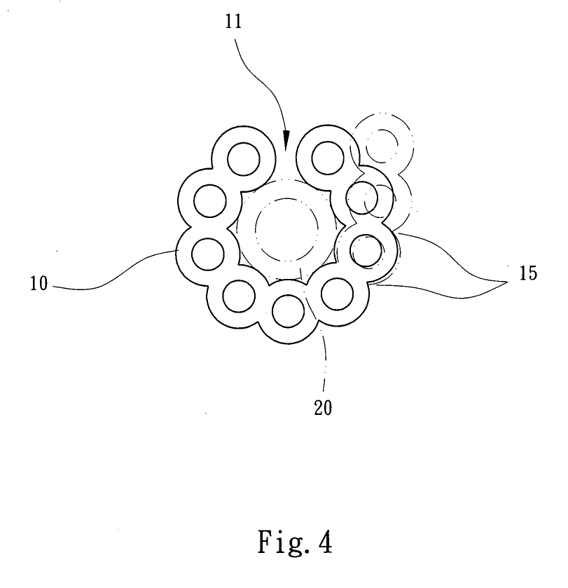

Referring to FIGS. 1 to 4, at least one of the inner and outer circumferential faces of the enclosing/binding sleeve 10 is formed with several channels 15 along the adjoining sides of each two adjacent receiving passages 13. Accordingly, the channels 15 serve as weakened sections which can be more easily folded. Therefore, the enclosing/binding sleeve 10 can be more easily stretched via the split 11 (as shown in FIG. 4) for conveniently mounting the enclosing/binding sleeve on the pipeline 20.

According to the above arrangement, the present invention can be highly elastically stretched to directly easily enlarge the size of the split 11. Accordingly, the fuel pipeline 20 can be easily held and bound in the holding space 120. By means of the high elasticity and softness of the enclosing/binding sleeve 10, the pipeline 20 can be fully snugly tightly clamped in the holding space 120. This eliminates the shortcoming of over-tightness or over-looseness existing in the conventional device.

Furthermore, the far-infrared generating units 14 are evenly distributed and accommodated in the receiving passages 13 of the enclosing/binding sleeve 10. Moreover, the sleeve 10 very evenly clamps and holds the pipeline 20. Therefore, far-infrared effect can be evenly provided for the pipeline 20.

The above embodiments are only used to illustrate the present invention, not intended to limit the scope thereof. Many modifications of the above embodiments can be-made without departing from the spirit of the present invention.

1. An activating/processing apparatus for liquid fuel, comprising an enclosing/binding sleeve made of highly elastic and heat-resistant gum material, the enclosing/binding sleeve having a substantially annular cross-section having a split, the enclosing/binding sleeve defining a central interior holding space for a fuel pipeline to pass therethrough, a wall of the enclosing/binding sleeve being formed with several axial receiving passages, whereby a far-infrared generating unit can be placed in each receiving passage.

2. The activating/processing apparatus for liquid fuel as claimed in claim 1, wherein the far-infrared generating units are cylindrical bodies which can be inserted in the receiving passages.

3. The activating/processing apparatus for liquid fuel as claimed in claim 1, wherein a sealing cap is detachably disposed at at least one end of the enclosing/binding sleeve for sealing the receiving passages.

4. The activating/processing apparatus for liquid fuel as claimed in claim 3, wherein at least one face of the sealing cap is formed with at least one cylindrical plug corresponding to the position and configuration of the receiving passage.

5. The activating/processing apparatus for liquid fuel as claimed in claim 1, wherein at least one of the inner and outer circumferential faces of the enclosing/binding sleeve is formed with several channels along the adjoining sides of at least two adjacent receiving passages.

6. The activating/processing apparatus for liquid fuel as claimed in claim 3, wherein at least one of the inner and outer circumferential faces of the enclosing/binding sleeve is formed with several channels along the adjoining sides of at least two adjacent receiving passages.

7. The activating/processing apparatus for liquid fuel as claimed in claim 4, wherein at least one of the inner and outer circumferential faces of the enclosing/binding sleeve is formed with several channels along the adjoining sides of at least two adjacent receiving passages.

8. The activating/processing apparatus for liquid fuel as claimed in claim 2, wherein a sealing cap is detachably disposed at at least one end of the enclosing/binding sleeve for sealing the receiving passages.

9. The activating/processing apparatus for liquid fuel as claimed in claim 2, wherein at least one of the inner and outer circumferential faces of the enclosing/binding sleeve is formed with several channels along the adjoining sides of at least two adjacent receiving passages.
